(19) United States
(12) Patent Application Publication
(10) Pub. No.: US 2014/0059093 A1
(43) Pub. Date: Feb. 27, 2014

(54) INFORMATION PROCESSING METHOD AND APPARATUS FOR GARBAGE COLLECTION

(71) Applicant: FUJITSU LIMITED, Kawasaki-shi (JP)

(72) Inventor: Katsutomo SEKIGUCHI, Numazu (JP)

(73) Assignee: FUJITSU LIMITED, Kawasaki-shi (JP)

(21) Appl. No.: 13/972,179

(22) Filed: Aug. 21, 2013

(30) Foreign Application Priority Data
Aug. 24, 2012 (JP) 2012-184922

(51) Int. Cl. G06F 12/02

(52) U.S. Cl. CPC G06F 12/0269
USPC 707/816; 707/819

(57) ABSTRACT

A disclosed method includes: specifying a first object pointed by a first pointer, wherein the first object is in a heap area that includes plural generational areas; determining whether or not an address in a generational area, which is different from a first generational area that includes the first object, is set as a movement destination address of the first object; upon determining that the address is set as the movement destination address of the first object, obtaining the movement destination address of the first object; and updating the first pointer with the movement destination address of the first object.

### CROSS-REFERENCE TO RELATED APPLICATIONS

This application is based upon and claims the benefit of priority of the prior Japanese Patent Application No. 2012-184922, filed on Aug. 24, 2012, the entire contents of which are incorporated herein by reference.

### FIELD

This invention relates to garbage collection.

### BACKGROUND

In throughput-oriented garbage collection that is called a stop-the-world type, a processing of an application program that use a heap area is stopped when actually starting the garbage collection.

On the other hand, in a parallel-type garbage collection (also called concurrent garbage collection), a part of a processing in the garbage collection can be performed in parallel with a processing of an application program.

As the parallel-type garbage collection, a following technique is known, for example. More specifically, a technique exists, that performs a processing for an application program in parallel with marking by managing available areas with a free list without rearranging live objects. However, there is a problem in this technique that available areas are partitioned.

Moreover, in order to resolve the problem that the available areas are partitioned, there is a technique for rearranging the live objects. In this technique, when the live objects are rearranged, a period while the processing for the application program is stopped is shortened by limiting the area of the rearrangement destination.

In addition, there is another technique for performing marking and saving (here, including rearrangement and update of reference pointers) in parallel with the processing for the application program by using a read barrier. In this technique, the read barrier is used for detection of additional reference pointers for which the marking is required and detection of saved objects.

Furthermore, a technique exists that the live objects in a young generation (which is also called a first generation) are saved in parallel with the processing for the application program.

However, when updating the reference pointers, it is typically necessary to scan the entire memory space to detect all reference pointers, and it takes a long time for the update. Therefore, in case of the parallel-type garbage collection in which the processing for the application program is stopped when updating the reference pointers, the stop time for the processing for the application program may become long.

Moreover, the aforementioned technique is not enough to execute a processing for moving the live objects (i.e. processing for copying the live objects to an area of a movement destination) in parallel with the processing for the application program, especially. Although a method that uses the read barrier is employed in the aforementioned example, there is a problem in which a processing cost of such a method is expensive.

In other words, any conventional technique does not exist in which the stop time for the processing for the application program is effectively shortened.

### SUMMARY

An information processing method relating to this invention includes: (A) specifying a first object pointed by a first pointer, wherein the first object is in a heap area that includes plural generational areas; (B) determining whether or not an address in a generational area, which is different from a first generational area that includes the first object, is set as a movement destination address of the first object; (C) upon determining that the address is set as the movement destination address of the first object, obtaining the movement destination address of the first object; and (D) updating the first pointer with the movement destination address of the first object.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1 is a functional block diagram of an information processing apparatus in this embodiment;

FIG. 2 is a diagram depicting a processing flow of a processing executed from creating a generational area to releasing the generational area;

FIG. 3 is a diagram to explain a progress of phases;

FIG. 4 is a diagram to explain access to a heap area;

FIG. 5 is a diagram to explain state transitions of the generational area;

FIG. 6 is a diagram depicting a processing flow of a marking processing;

FIG. 7 is a diagram depicting a processing flow of the marking processing;

FIG. 8 is a diagram to explain update of a reference pointer;

FIG. 9 is a diagram depicting a processing flow of a release processing;

FIG. 10 is a diagram depicting a processing flow of a securing processing;

FIG. 11 is a diagram depicting a processing flow of a movement processing;

FIG. 12 is a diagram depicting an example that a processing for moving an object is executed in parallel;

FIG. 13 is a diagram depicting an example that the processing for moving the object is executed in parallel;

FIG. 14 is a diagram depicting a processing flow of a setting processing;

FIG. 15 is a diagram depicting a processing flow of a processing executed when an application processing unit accesses an object;

FIG. 16 is a diagram to explain a generation management table;

FIG. 17 is a diagram depicting state transitions of the generational area;

FIG. 18 is a diagram depicting an example of a program executed as an accessor;

FIG. 19 is a diagram depicting an example of a program executed as an accessor;

FIG. 20 is a diagram depicting a processing flow of a processing executed when the application processing unit accesses an object;

FIG. 21 is a diagram depicting a specific example for writing to an object;

FIG. 22 is a diagram depicting a specific example for writing to an object;

FIG. 23 is a diagram depicting a specific example for writing to an object; and

FIG. 24 is a functional block diagram of a computer.

### DESCRIPTION OF EMBODIMENTS

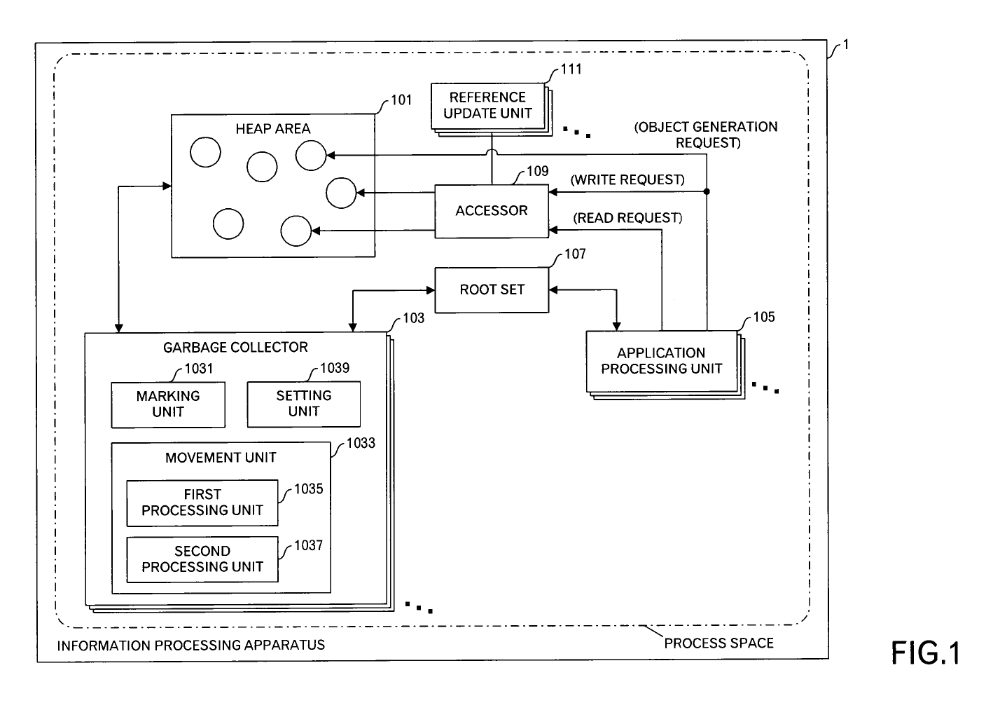

FIG. 1 illustrates a functional block diagram of an information processing apparatus 1 in this embodiment. The information processing apparatus 1 includes a heap area 101, a garbage collector 103 including a marking unit 1031, movement unit 1033 and setting unit 1039, an application processing unit 105, a root set 107, an accessor 109 and a reference update unit 111. Moreover, the movement unit 1033 includes a first processing unit 1035 and a second processing unit 1037. These processing units and the like can be implemented in a single process space.

The heap area 101 is a memory area used when the application processing unit 105 executes a processing. In the heap area 101, an object is generated in response to an object generation request from the application processing unit 105. In this embodiment, an object is an area in which data is stored. A circle figure in the heap area 101 represents an object. The heap area 101 is divided into plural generational areas, each of which has a predetermined size. The generational area is a division unit of the heap area in garbage collection by generation. In this embodiment, the size of the generational area is a multiple of the page size that is a unit of a memory protection. However, the number of generational areas is not limited.

The garbage collector 103 performs garbage collection. The marking unit 1031 performs a processing in a mark phase. The first processing unit 1035 and second processing unit 1037 in the movement unit 1033 perform a processing in a movement phase. The setting unit 1039 performs a processing in a reference update phase. The number of garbage collectors 103 may be plural.

The application processing unit 105 operates as an interpreter or compiler to process an application program developed by a user. The application processing unit 105 is a user thread, for example. The application processing unit 105 outputs an object generation request to generate an object in the heap area 101. The application processing unit 105 outputs a read request or write request to access the object through the accessor 109. The number of application processing units 105 may be plural.

The root set 107 is a set of reference pointers. In case of the set of reference pointers, the root set 107 includes reference pointers that exist, for example, in a stack and registers, and reference pointers held by a system (e.g. a JAVA (registered trademark) virtual machine or the like). In this embodiment, a pointer that points to the object is called the reference pointer.

The accessor 109 accesses an object in the heap area 101 in response to a request from the application processing unit 105. Moreover, the accessor 109 causes the reference update unit 111 provided for each generational area to update the reference pointers.

(1) Outline of the Parallel-Type Garbage Collection in this Embodiment

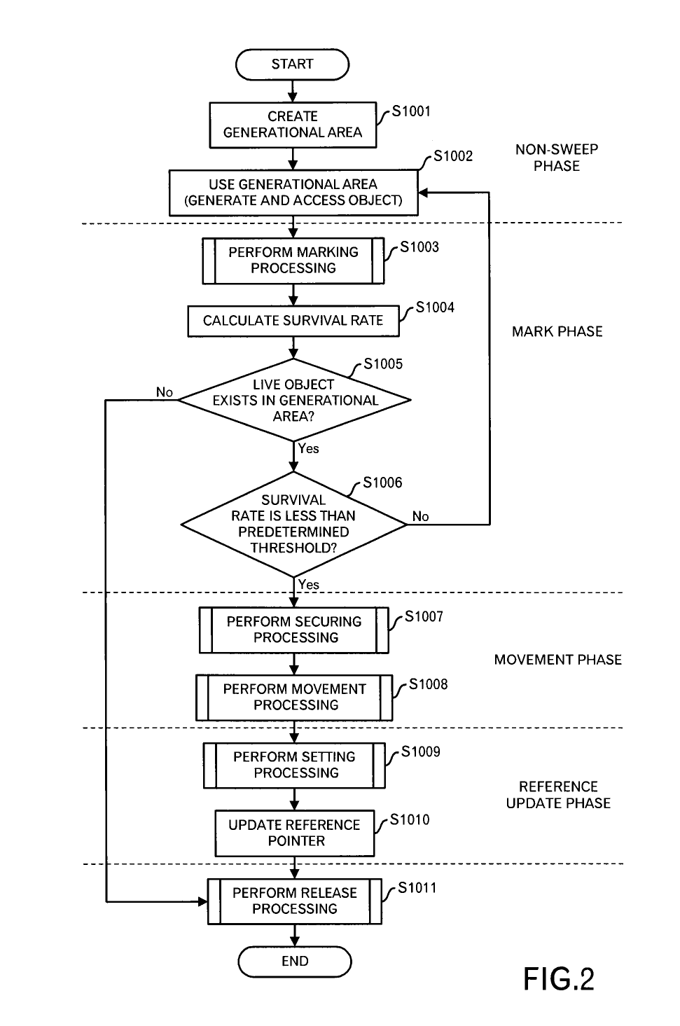

A phase transition in the parallel-type garbage collection will be explained by using FIG. 2. FIG. 2 illustrates a processing flow of a processing that is carried out from creating a specific generational area to releasing the specific generational area. “Parallel” means that different tasks are executed simultaneously.

The parallel-type garbage collection in this embodiment includes a non-sweep phase, a mark phase, a movement phase and a reference update phase.

The non-sweep phase includes steps S1001 and S1002.

The garbage collector 103 creates a generational area (step S1001). More specifically, in case of a UNIX (registered trademark)-like Operating System (OS), for example, an area that was PROT_NONE (i.e. unused area) is set as “PROT_READ|PROT_WRITE. This processing is also called a memory commit.

The application processing unit 105 generates an object in the created generational area, and accesses the object (step S1002). In the non-sweep phase, when the application processing unit 105 accesses the object, the write barrier or reference update processing is not performed.

The mark phase includes steps S1003 to S1006.

The marking unit 1031 performs a marking processing (step S1003). More specifically, the marking unit 1031 attaches a mark representing it is a live object to an object that is reachable by a reference pointer. The marking processing will be explained in detail later. Moreover, a live object is an object that is reachable by a reference pointer.

The marking unit 1031 calculates a survival rate of the objects (step S1004). The survival rate is calculated, for example, based on the size or number of live objects to the size of the generational area.

The marking unit 1031 determines whether or not any live object exists in the generational area (i.e. whether or not the survival rate is equal to 0%) (step S1005). When any live object does not exist in the generational area (step S1005: No route), in other words, when the survival rate is equal to 0%, the generational area can be released. Therefore, the processing shifts to a processing of step S1011.

On the other hand, when the live object exists in the generational area, in other words, when the survival rate of the objects is not equal to 0% (step S1005: Yes route), the marking unit 1031 determines whether or not the survival rate is less than a predetermined threshold (step S1006). The threshold is 50%, for example.

When the survival rate is equal to or greater than the predetermined threshold (step S1006: No route), the generational area cannot be released, so the processing returns to the processing of the step S1002. On the other hand, when the survival rate is less than the predetermined threshold (step S1006: Yes route), the processing shifts to step S1007.

Thus, until the generational area that is a target of the garbage collection (hereinafter, referred to a generational area of a sweep target) is determined, an object is not swept even when the object is not required, and any object in the generational area is not moved.

The movement phase includes steps S1007 and S1008.

The first processing unit 1035 in the movement unit 1033 performs a securing processing (step S1007). More specifically, a movement destination area of an object in the generational area of the sweep target is secured. The securing processing will be explained in detail later.

The second processing unit 1037 in the movement unit 1033 performs a movement processing (step S1008). More specifically, the object of the generational area that is the sweep target is copied to the secured area. The movement processing will be explained in detail later.

The reference update phase includes steps S1009 and S1010. The reference update means that the reference pointer that points to an object of a movement source is updated to an address of an object of a movement destination so that the object of the movement destination is correctly referenced.

The setting unit 1039 performs a setting processing of the reference update (step S1009). The setting processing of the reference update will be explained in detail later. Then, when the setting processing of the reference update is performed, the application processing unit 105 updates the reference pointers (step S1010). Moreover, when a next mark phase starts, the marking unit 1031 also updates the reference pointers.

Then, the garbage collector 103 performs a release processing (step S1011). More specifically, an area that was PROT_READ (i.e. an area that was read-only), for example, is set as PROT_NONE (an area to which access is impossible). This processing is called a memory uncommit. The release processing will be explained in detail later. Then, the processing ends.

Thus, as long as an object dose not become the sweep target, the non-sweep phase and mark phase are mutually repeated. As a result of the mark phase, the generational area that became the sweep target will be released after the movement phase and reference update phase.

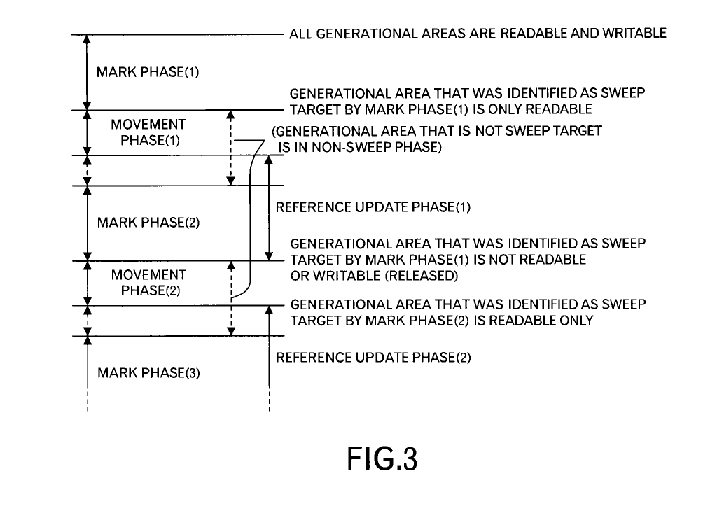

Next, a progress of the parallel-type garbage collection in this embodiment will be explained by using FIG. 3. It is presumed that following operation conditions are set.

(a) In the mark phase, all generational areas are simultaneously processed. (b) The phase of the generational area that is determined not to be the sweep target in the mark phase shifts to the non-sweep phase. (c) The movement phase and reference update phase are performed only for the generational area that is the sweep target. (d) The period of the mark phase overlaps with the period of the reference update phase. When the mark phase is complete, the reference update phase is also complete. (e) After the movement phase is complete, a pause period of the garbage collector 103 may be provided based on the size of the heap area 101 or the progress or the like of the garbage collection, until the next mark phase starts. (f) When creating the generational area, the reference update processing that is executed when the application processing unit 105 accesses the generational area is set to be invalid, and at the beginning of the reference update phase, the reference update processing is set to be valid. (g) In the movement phase, writing to the objects in the generational area of the sweep target is prohibited. (h) When the reference update phase is complete, the generational area is released.

First, when the mark phase (1) is performed, the generational area of the sweep target is identified. The phase of the generational area of the sweep target is shifted to the movement phase (1), and the phase of the generational area that is not the sweep target is shifted to the non-sweep phase. In the movement phase (1), the generational area of the sweep target is set only to be readable. The generational area of the non-sweep phase is writable and readable. The period of the non-sweep phase is a period after the mark phase is complete and before the next mark phase for the generational area that is not the sweep target starts.

When the movement phase (1) is complete, the reference update phase (1) starts. In the reference update phase (1), the setting unit 1039 sets the reference update processing as being valid. Then, the reference pointer that points to an object moved in the movement phase (1) is updated when the application processing unit 105 accesses that object. Moreover, when the mark phase (2) starts, the marking unit 1031 updates the reference pointer. Then, when the reference update phase (1) and the mark phase (2) are complete, the generational area that became the sweep target in the mark phase (1) is set as being not readable or writable (i.e. becomes a state in which the generational area is released and unused).

When the mark phase (2) is performed, the generational area of the sweep target is identified. The phase of the generational area of the sweep target is shifted to the movement phase (2), and the phase of the generational area that is not the sweep target is shifted to the non-sweep phase. In the movement phase (2), the generational area of the sweep target is set so as to be only readable. The generational area in the non-sweep phase is readable and writable.

When the movement phase (2) is complete, the reference update phase (2) starts. In the reference update phase (2), the setting unit 1039 sets the reference update processing so as to be valid. Then, the reference pointer that points to an object moved in the movement phase (2) is updated when the application processing unit 105 accesses that object. Moreover, when the mark phase (3) starts, the marking unit 1031 updates the reference pointer.

Thus, the reference update for the generational area that is identified as the sweep target in the marking processing is performed by the application processing unit 105 after the marking processing or performed in the next marking processing. Moreover, because only reading is possible in the movement phase, it is secured that the object of the movement source is the same as the object of the movement destination. Furthermore, there is no need to stop the processing of the application processing unit 105 for reading, and it is possible that the application processing unit 105 normally performs a processing for the generational area that is not the sweep target.

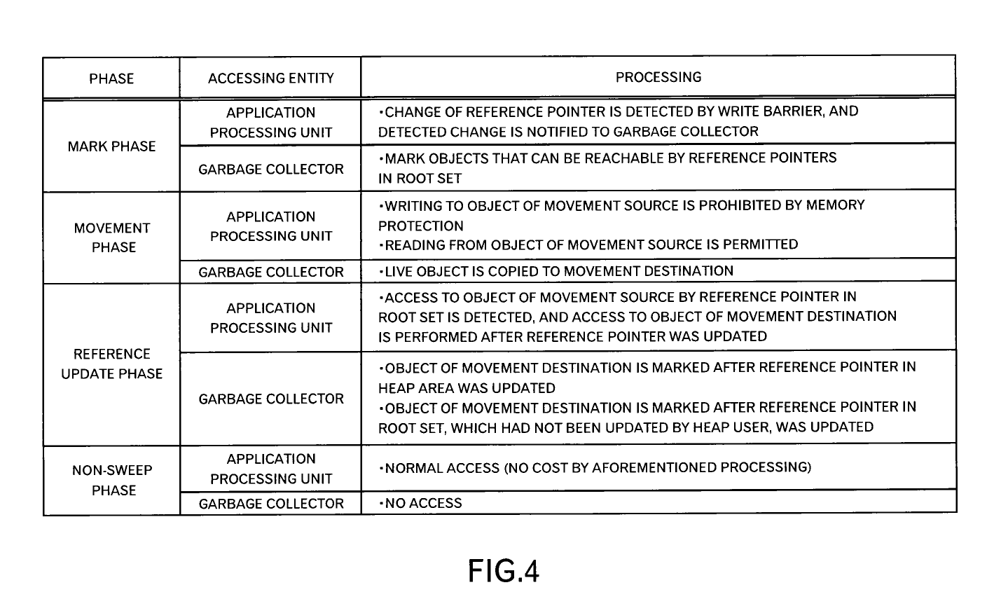

FIG. 4 illustrates accesses conducted for the heap area 101 in each phase. In FIG. 4, a processing associated with the accesses to the heap area 101 is illustrated for each of the application processing unit 105 and garbage collector 103 and for each phase.

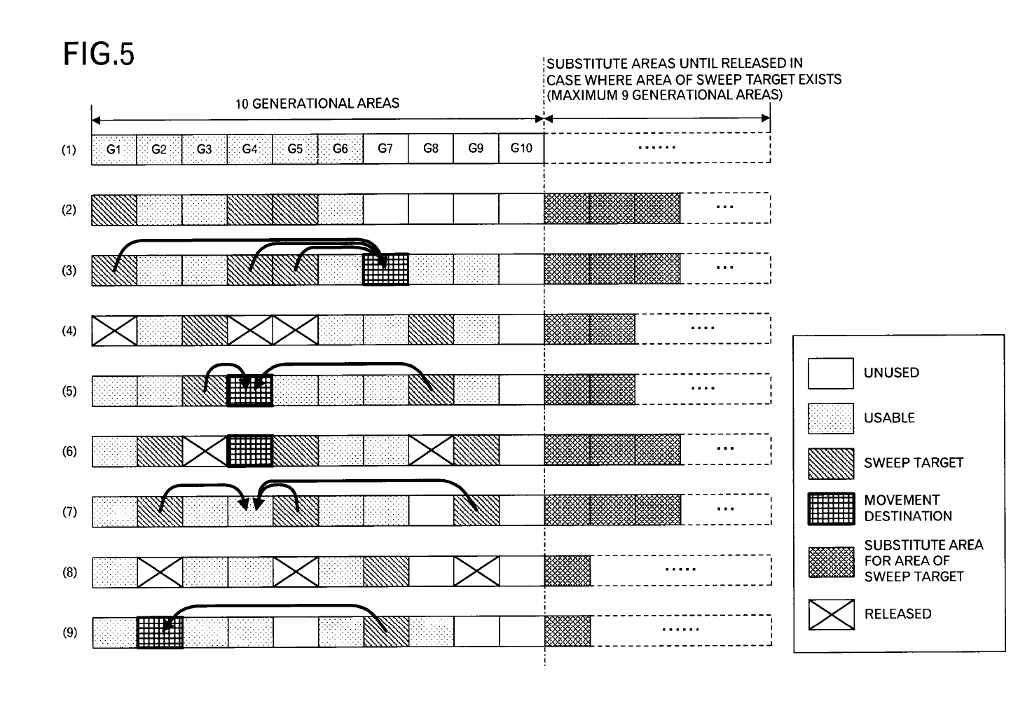

Next state, transitions of the generational area will be explained by using FIG. 5.

As presumption, as illustrated in (1), 10 generational areas G1 to G10 are provided in the heap area 101, and the generational areas G1 to G6 are usable, and G7 to G10 are unused. In addition, it is presumed that, when the half or more of the generational areas (i.e. 5 or more generational areas) becomes usable, the mark phase starts. Furthermore, an object generated before the beginning of the mark phase is to be marked, and an object generated after the beginning of the mark phase is handled as a root.

It is presumed that, as a result of the mark phase, the generational areas G1, G4 and G5 are identified as the sweep targets and are in a state of (2). Because three generational areas of the sweep targets exist, the state shifts to a state in which three substitute areas can be set up. The reason why such substitute areas are prepared is as follows: Namely, because the object exists in both of the generational area of the movement source and generational area of the movement destination until the generational area is released, the usable heap areas are decreased by that duplication. Then, the substitute areas are prepared in order to always enable 10 generational areas to be used.

It is presumed that a state illustrated in (3) is obtained as a result that G7 is secured as the movement destination of the objects in G1, G4 and G5, and G8 and G9 are newly generated. When the movement phase is complete, the reference update phase begins. Then, the mark phase begins, because the number of generational areas being used becomes 5 or more.

It is presumed that, as a result that the mark phase was performed, G3 and G8 become the sweep target, G1, G4 and G5 are released, and then, a state (4) is obtained. Because there are two generational areas that are the sweep targets, a state in which two substitute areas can be set up is obtained.

It is presumed that, as a result that G4 is secured as the movement destination of the objects in G3 and G8, and G1 and G5 are set up, a state illustrated in (5) is obtained. When the movement phase is complete, the reference update phase begins. Then, because the number of generational areas being used becomes or more, the mark phase starts.

It is presumed that, as a result of the mark phase, G2, G5 and G9 become the sweep target, G3 and G8 are released, and a state (6) is obtained. Because the number of generational areas that are the sweep targets is 3, a state that three substitute areas can be set up is made.

It is presumed that, as a result that G4 is identified as the movement destination of the objects in G2, G5 and G9, and G3 is set up, a state illustrated in (7) is obtained. When the movement phase is completed, the reference update phase begins. Then, because the number of generational areas being used becomes 5 or more, the mark phase starts.

It is presumed that, as a result of the mark phase, G7 is identified as the sweep target, G2, G5 and G9 are released, and the state shifts to a state (8). Because one generational area of the sweep target exists, a state that one substitute area can be set up is made.

It is presumed that, as a result that the movement destination of the objects in G7 becomes G2, and G8 is set up, a state illustrated in (9) is obtained. When the movement phase is complete, the reference update phase begins. Then, because the number of generational areas being used becomes 5 or more, the mark phase starts.

In the aforementioned example, because there is a possibility that 9 generational areas becomes the sweep target at the greatest, an address space for 9 generational areas may be reserved in advance as the substitute areas for the generational areas of the sweep target.

(2) Mark Phase

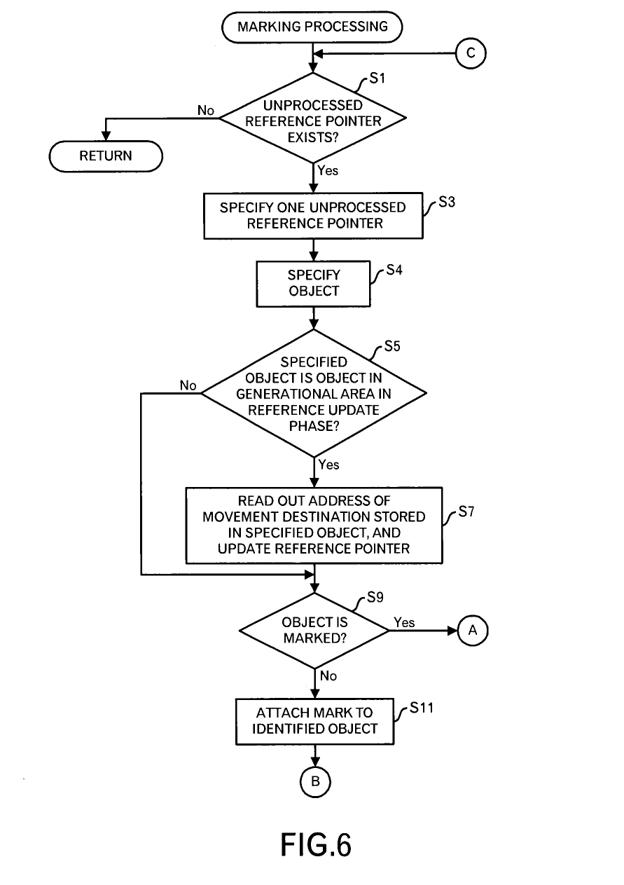

Next, the marking processing executed by the marking unit 1031 will be explained by using FIGS. 6 to 8.

The marking unit 1031 determines whether or not there is an unprocessed reference pointer (FIG. 6: step S1). At the step S1, it is determined whether or not there is an unprocessed reference pointer among reference pointers included in the root set 107 and reference pointers detected by the write barrier or remark.

The write barrier is to detect a change of a reference relationship among the objects, which is made by rewriting, by the application processing unit 105, data stored in the objects. The remark is a processing to detect a difference with the root set 107 at the beginning of the mark phase in the parallel-type marking and stop the processing of the application processing unit 105 to perform the marking again. Typically, because the difference is a few, the stop time for the processing of the application processing unit 105 does not become any problem. The write barrier and remark may not be performed if this state is a state before the mark phase begins. However, after the mark phase begins, the write barrier and remark are performed, because the reference point that points to the object of the movement source (i.e. unnecessary objects) is invalid.

When there is no unprocessed reference point (step S1: No route), the processing returns to the calling-source processing. On the other hand, when there is an unprocessed reference pointer (step S1: Yes route), the marking unit 1031 specifies one unprocessed reference pointer (step S3). Moreover, the marking unit 1031 specifies an object pointed by the specified reference pointer from the heap area 101 (step S4).

The marking unit 1031 determines whether or not the specified object is an object in the generational area of the reference update phase (step S5). At the step S5, it is determined based on whether or not the address of the movement destination is stored in the specified object. The object in the generational area of the reference update phase is the object of the movement source, and the address of the movement destination is stored in the object of the movement source in the movement phase immediately before.

When the reference pointer does not point to any object in the generational area of the reference update phase (step S5: No route), the update of the reference pointer is not required, and the processing shifts to a processing of step S9. On the other hand, when the reference pointer points to an object in the generational area of the reference update phase (step S5: Yes route), the marking unit 1031 performs a following processing. More specifically, the marking unit 1031 reads out the address of the movement destination, which is stored in the object pointed by the reference pointer, and updates the reference pointer with the address of the movement destination (step S7).

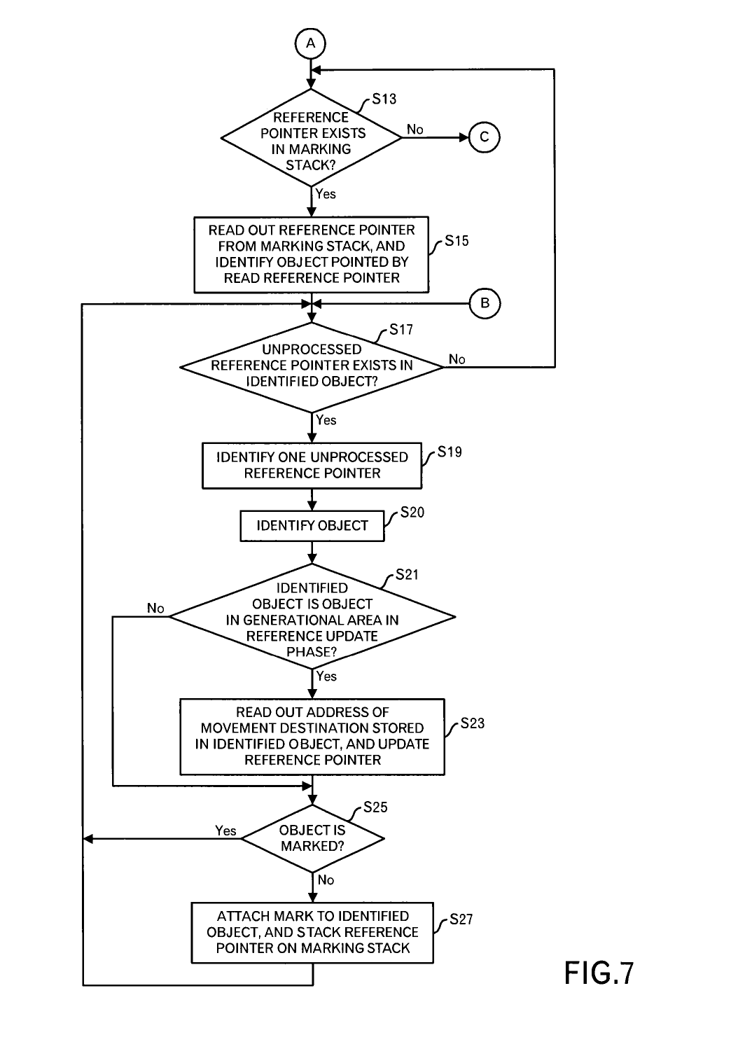

The marking unit 1031 determines whether or not there is a mark for the object pointed by the reference pointer (step S9). When there is no mark (step S9: No route), the marking unit 1031 attaches a mark to the object pointed by the reference pointer (step S11). Then, the processing shifts to step S17 in FIG. 7 through terminal B. When the reference pointer is updated at the step S7, the mark is attached to the object of the movement destination.

On the other hand, when there is the mark (step S9: Yes route), a reference pointer in a marking stack is processed. Therefore, the processing shifts to step S13 in FIG. 7 through terminal A.

Shifting to explanation of FIG. 7, the marking unit 1031 determines whether or not there is a reference pointer in the marking stack (step S13). The marking stack is a storage area to store reference pointers detected while tracking the references. The marking unit 1031 can reach objects that can be reached without exception by tracing the references by utilizing the marking stack. A technique for tracing the references by using the marking stack is a well-known, so detailed explanation is omitted.

When there is a reference pointer in the marking stack (step S13: Yes route), the marking unit 1031 reads out a reference pointer from the marking stack, and identifies an object pointed by that reference pointer (step S15). When the reference pointer does not exist in the marking stack (step S13: No route), a next reference pointer is processed. Therefore, the processing returns to the step S1 in FIG. 6 through terminal C.

The marking unit 1031 determines whether or not an unprocessed reference pointer is stored in the object identified at the step S15 or the object to which the mark is attached at the step S11 (step S17).

When there is no unprocessed reference pointer (step S17: No route), a next reference pointer in the marking stack is processed. Therefore the processing returns to the processing of the step S13. On the other hand, when there is an unprocessed reference pointer (step S17: Yes route), the marking unit 1031 identifies one unprocessed reference pointer (step S19). Moreover, the marking unit 1031 identifies an object pointed by the identified reference pointer from the heap area 101 (step S20).

The marking unit 1031 determines whether or not the identified object is an object in the generational area of the reference update phase (step S21).

When the reference pointer does not point to the object in the generational area of the reference update phase (step S21: No route), the update of the reference pointer is not required. Therefore, the processing shifts to a processing of step S25. On the other hand, when the reference pointer points to the object in the generational area of the reference update phase (step S21: Yes route), the marking unit 1031 performs a following processing. More specifically, the marking unit 1031 reads out an address of the movement destination, which is stored in the object pointed by the reference pointer, and updates the reference pointer with the address of the movement destination (step S23).

The marking unit 1031 determines whether or not there is a mark in the object pointed by the reference pointer (step S25). When there is no mark (step S25: No route), the marking unit 1031 attaches a mark to the object pointed by the reference pointer. Moreover, the marking unit 1031 stacks the reference pointer on the marking stack (step S27). When the reference pointer was updated at the step S23, the mark is attached to the object of the movement destination. Then, the processing returns to the processing of the step S17. Moreover, when there is the mark in the object (step S25: Yes route), the processing returns to the processing of the step S17.

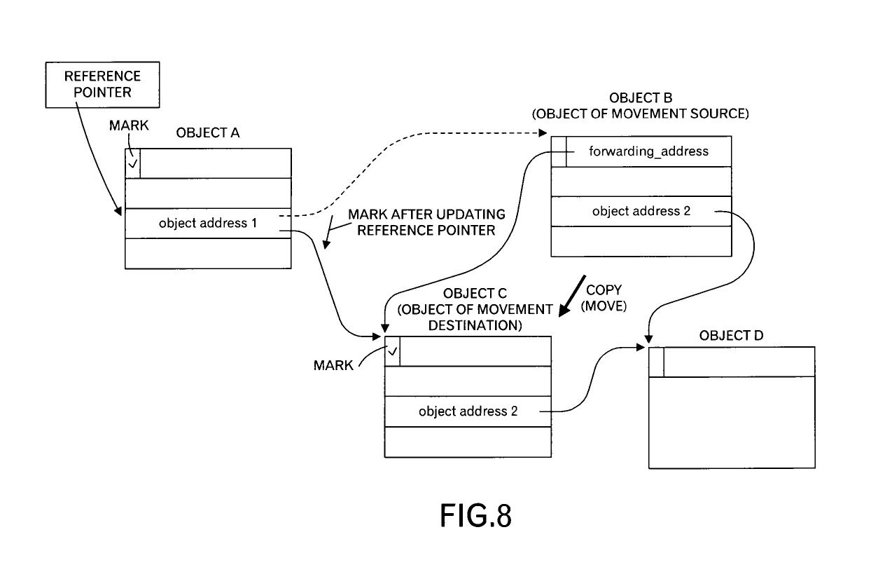

The update of the reference pointer will be explained in detail by using FIG. 8. In FIG. 8, objects are represented by 4 rectangular figures, and arrows represent the references, and the mark is attached to the live object. The reference pointer illustrated in the upper left of FIG. 8 points to object A. The reference pointer (object address 1) that points to object B is stored in the object A. In the marking processing, the object B is reached by the reference pointer that points to the object B, and the object B is the object of the movement source (i.e. object in the reference update phase). Therefore, no mark is attached to the object B, the address of the movement destination (forwarding_address) is readout, and the reference pointer is updated with the address of the movement destination. Old references are represented by dotted lines. Moreover, the object C that is the object of the movement destination is reached by the updated reference pointer, and the mark is attached to the object C. The reference pointer (object address 2) that points to object D is stored in the object C. Therefore, the object D is reached by the reference pointer stored in the object C.

As described above, in the marking processing, the reference pointers included in the root set 107 and reference pointers stored in the reached objects are scanned without exception. Therefore, when the marking processing is complete, the objects of the movement source are no longer reached.

Then, because the reference pointer that points to the reachable object is updated, the reference pointer that points to the unreachable object is not updated. In other words, because the wasteful reference update processing is omitted as a result, the stop time of the processing by the application processing unit 105 is reduced compared with some of the parallel-type garbage collections.

Moreover, even when the application processing unit 105 copies the old reference pointer to another area (e.g. heap area, stack area, local variable area, and an area that stores reference pointers held by the Java virtual machine or the like), the copy operation is detected by the write barrier or remark, and the copied reference pointer is notified to the marking unit 1031. Thus, it becomes possible to maintain consistency of the reference relationships among the objects without updating the reference pointers immediately after the movement of the objects.

(3) Release of Generational Areas

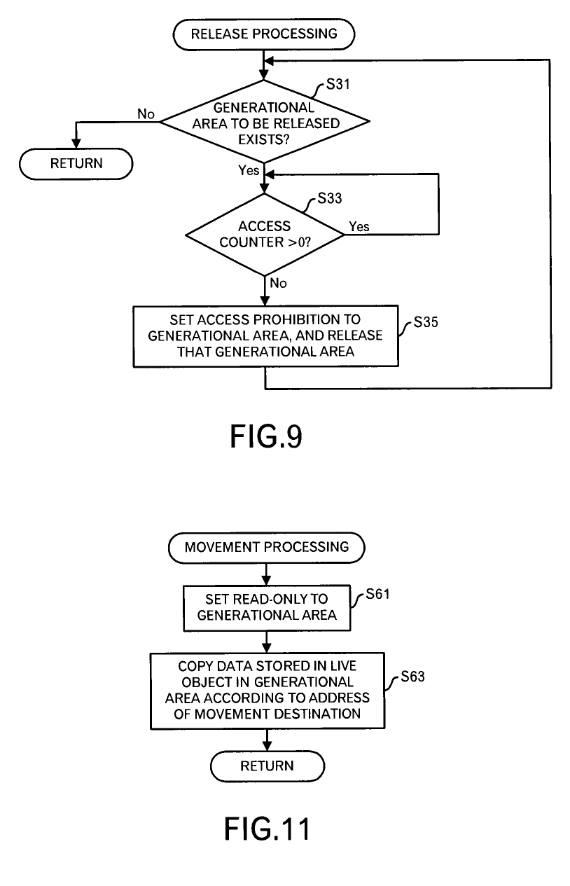

Next, the release processing (S1011) will be explained by using FIG. 9. The release processing can be executed in parallel with other processing. Here, “parallel” means that the same operations are processed duplicately.

When the mark phase is complete, the marking unit 1031 determines whether or not the generational area to be released exists (FIG. 9: step S31). At the step S31, it is determined whether or not the generational area that was the sweep target in the movement phase immediately before exists.

When there is no generational area to be released (step S31: No route), the processing returns to the calling-source processing. On the other hand, when there is the generational area to be released (step S31: Yes route), the marking unit 1031 determines whether or not a value of an access counter for that generational area is greater than “0” (step S33). When the value of the access counter is greater than “0” (step S33: Yes route), that generational area cannot be released. Therefore, the processing returns to the processing of the step S33, and the marking unit 1031 retries.

After the marking processing is complete, the application processing unit 105 does not newly access the object in the generational area that was the sweep target in the movement phase immediately before. Therefore, when the mark phase is complete, the generational area that was the sweep target in the movement phase immediately before can be released, basically. However, there is a possibility that, before the mark phase is complete, the execution of the accessor 109 that intends to access the object in the generational area that was the sweep target in the movement phase immediately before starts, and before the access is complete, the mark phase is completed, and the generational area is released. In such a case, there is a possibility that the address of the movement destination cannot be read out, or the reference pointer is updated with wrong data, because the released generational area is newly set up. In order to avoid such a problem, after it is confirmed that there is no application processing unit 105 that accesses the object in the generational area by using the access counter, the generational area is released.

When the value of the access counter is equal to or less than “0” (step S33: No route), the marking unit 1031 sets access prohibition to that generational area, and releases that generational area (step S35). At the step S35, for example, PROT_NONE is set to prohibit from reading and writing. Then, the processing returns to the step S31.

By carrying out the aforementioned processing, it becomes possible to release the generational area without any occurrence of errors or the like.

(4) Movement Phase

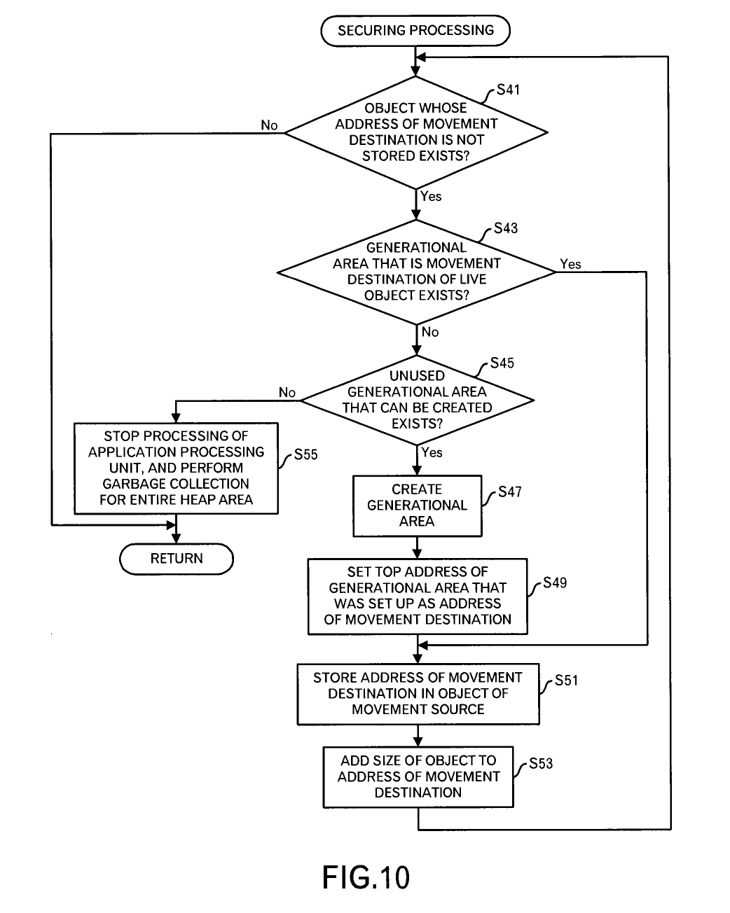

Next, a processing executed by the movement unit 1033 in the movement phase will be explained by using FIGS. 10 to 13. First, the securing processing (S1007) will be explained by using FIG. 10. The securing processing is executed for each generational area.

The first processing unit 1035 in the movement unit 1033 determines whether or not there is an object whose address of the movement destination is not stored in the generational area of the sweep target (FIG. 10: step S41). When there is no object whose address of the movement destination is not stored (step S41: No route), the area of the movement destination has been secured, and the processing returns to the calling-source processing.

On the other hand, when there is an object whose address of the movement destination is stored (step S41: Yes route), the first processing unit 1035 determines whether or not there is a generational area for the movement destination of that live object (step S43). When there is a generational area for the movement destination of that live object (step S43: Yes route), the address of the movement destination is set at an end position of the objects that exist in the generational area of the movement destination. Therefore, the processing shifts to a processing of step S51.

When there is no generational area for the movement destination of the live object (step S43: No route), the first processing unit 1035 determines whether or not there is an unused generational area that can be set up (step S45). When there is no unused generational area that can be set up (step S45: No route), the parallel-type garbage collection in this embodiment cannot be performed. Therefore, the first processing unit 1035 stops a processing of the application processing unit 105. Moreover, the first processing unit 1035 performs the garbage collection for the entire heap area 101 (step S55). Then, the processing returns to the calling-source processing.

On the other hand, when there is an unused generational area that can be set up (step S45: Yes route), the first processing unit 1035 newly sets up a generational area (step S47). When the garbage collection is performed, it is preferable that the lives of the objects that exist in the same generational area are almost the same. However, the life of an object that has just been generated is often shorter than objects that experienced the garbage collection. Therefore, it is preferable that the generational area in which an object is newly generated is different from the generational area that is the movement destination (i.e. save destination).

The first processing unit 1035 sets a top address of the generational area that was set up as the address of the movement destination (step S49), stores the address of the movement destination in the object of the movement source (step S51). Moreover, the first processing unit 1035 adds the size of the object to the address of the movement destination (step S53). In other words, the address of the movement destination is newly set. Then, the processing returns to the processing of the step S41.

By carrying out the aforementioned processing, an area for the movement destination of the live object is secured, appropriately.

Next, the movement processing (S1008) will be explained by using FIG. 11. The movement processing is performed for each generational area.

The second processing unit 1037 in the movement unit 1033 sets “read-only” to the generational area of the sweep target (FIG. 11: step S61). At the step S61, by setting PROT_READ, for example, the generational area is readable, but the writing to the generational area is prohibited.

When accessing the generational area for which access is restricted by the memory protection, a segment exception occurs. The segment exception is a synchronous signal, and the application processing unit 105 (i.e. thread) that caused the trap performs a processing of a trap handler by itself. Therefore, plural application processing units 105 in the process can process the trap handler, simultaneously. With the trap handler, the application processing unit 105 waits for a waiting event for an access restart, and restarts the processing from the top of the accessor 109 when the access restart is notified.

Returning to the explanation of FIG. 11, the second processing unit 1037 copies data stored in the live object in the generational area of the sweep target according to the address of the movement destination stored in the live object (step S63). Then, the processing ends.

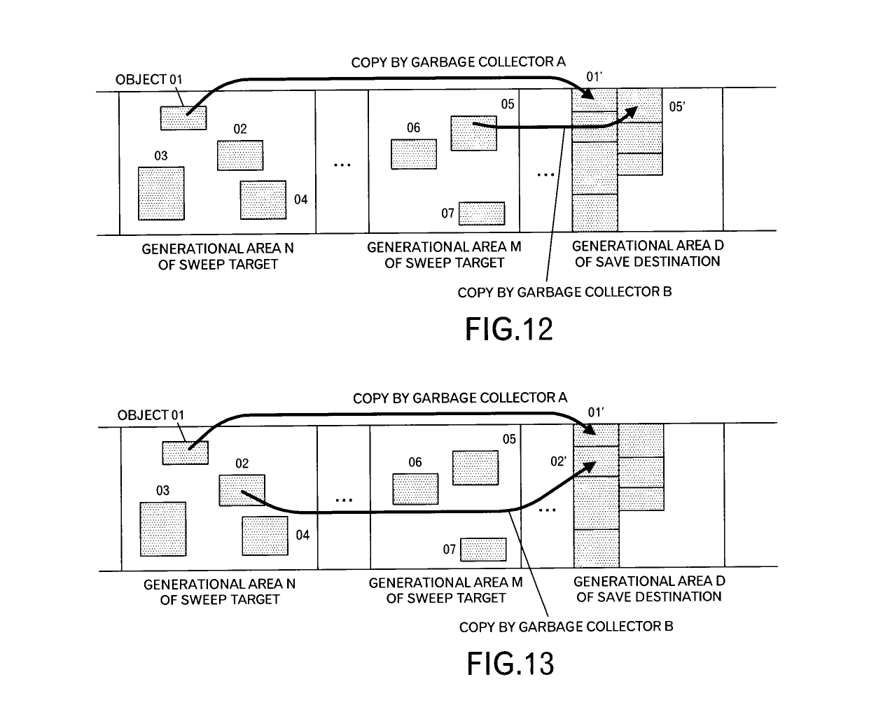

When there is enough room in the calculation resource of the information processing apparatus 1, the copy processing at the step S63 may be executed in parallel. For example, as illustrated in FIG. 12, the second processing unit 1037 may be allocated for each generational area, and the processing of the second processing units 1037 may be executed in parallel. In addition, for example, as illustrated in FIG. 13, plural second processing units 1037 may be allocated to one generational area, and the processing of the second processing units 1037 may be executed in parallel. Furthermore, the method as illustrated in FIG. 12 and the method as illustrated in FIG. 13 may be combined. Colored rectangles represent objects in FIGS. 12 and 13. The objects before the movement are objects 01 to 07, and a dash is attached to each of the objects after the movement.

By carrying out the aforementioned processing, even when the object is being moved, there is no need to stop reading the object in the generational area of the sweep target. Moreover, there is also no need to stop writing and reading the object in the generational area that is not the sweep target. Accordingly, the response time of the application can be uniformed (i.e. it is possible to enhance the response capability).

Moreover, because writing to the object in the generational area of the sweep target is prohibited, it is secured that the object of the movement destination is the same as the object of the movement source.

(5) Reference Update Phase

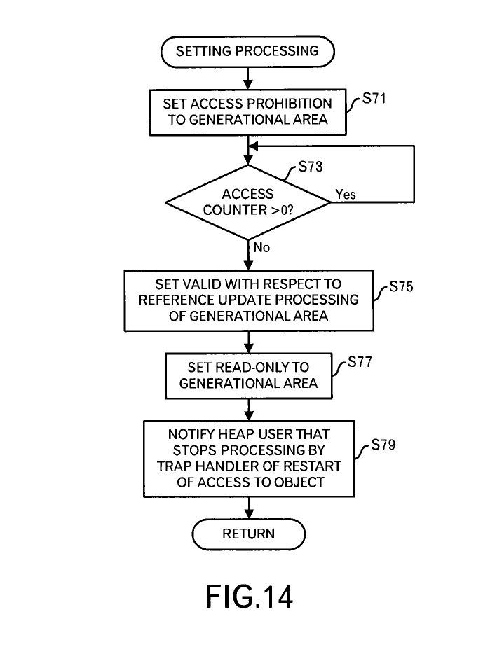

Next, the setting processing (S1009) executed by the setting unit 1039 in the reference update phase will be explained by using FIG. 14. The reference update processing is performed for each generational area.

First, the setting unit 1039 sets access prohibition to the generational area of the sweep target (FIG. 14: step S71). At the step S71, for example, by setting PROT_NONE, the writing and reading are prohibited. This is because the delay of the processing executed by the setting unit 1039 due to the accessor 109 being repeatedly invoked is avoided.

The setting unit 1039 determines whether or not the value of the access counter for the generational area of the sweep target is greater than “0” (step S73). When the value of the access counter is greater than “0” (step S73: Yes route), it is impossible to release that generational area. Therefore, the processing returns to the processing of the step S73, and the setting unit 1093 retries.

When the value of the access counter is equal to or less than “0” (step S73: No route), the setting unit 1039 sets “valid” to the reference update processing of the generational area of the sweep target (step S75). More specifically, it becomes possible that the reference pointer can be updated by the application processing unit 105 through the reference update unit 111.

The setting unit 1039 sets read-only to the generational area of the sweep target (step S77). At the step S77, for example, by setting PROT_READ, reading is enabled, however, writing is prohibited.

The setting unit 1039 notifies the application processing unit 105 that stops the processing by the trap handler of the restart of the access to the object (step S79). In other words, information representing that the reading can be restarted is notified to the application processing unit 105 that stops the processing by the trap handler because the access prohibition was set to the generational area of the sweep target.

By carrying out the aforementioned processing, the application processing unit 105 that stops the processing by the trap handler can update the reference pointers after returning from the trap handler.

(6) Access by the Application Processing Unit 105

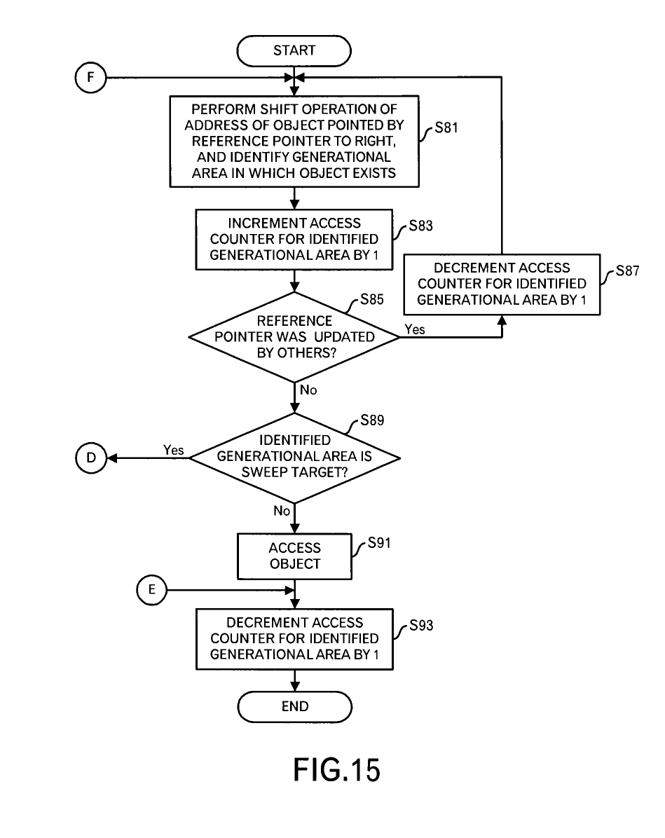

Next, a processing when the application processing unit 105 accesses the object will be explained by using FIGS. 15 to 23.

First, the application processing unit 105 executes a shift operation of an address of the object pointed by the reference pointer included in the root set 107 to the right, and identifies the generational area in which the object exists (FIG. 15: step S81).

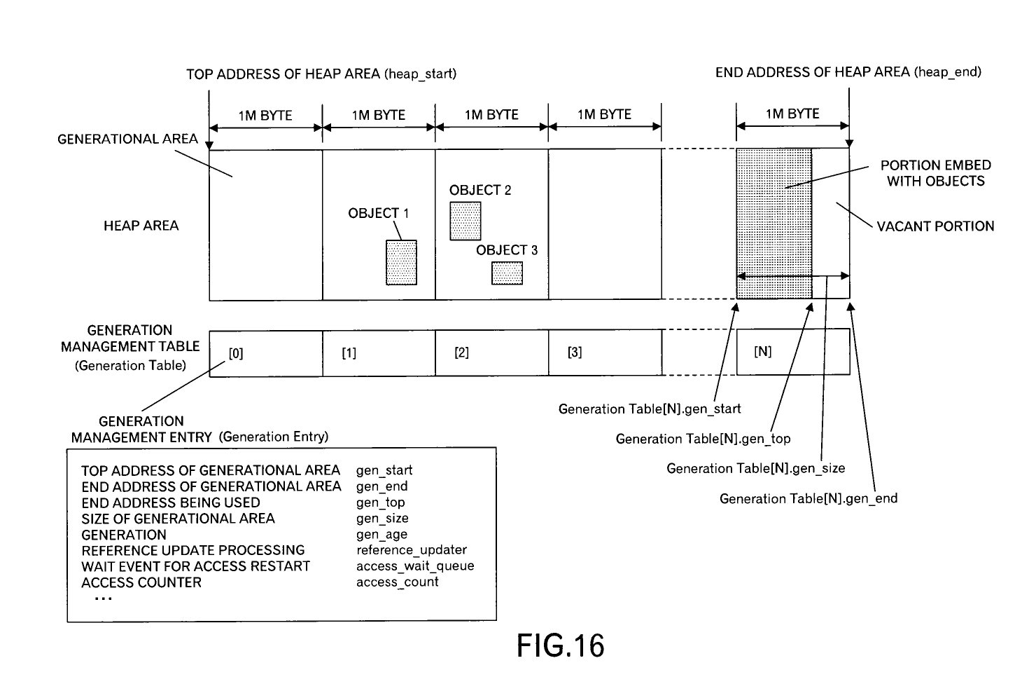

The processing of the step S81 will be explained by using FIG. 16. In an example of FIG. 16, N generational areas having a size of 1 M bytes and a generation management table corresponding to each generational area are illustrated. The colored area is an area in which the object exists. The generation management table is provided in a memory area different from the heap area 101. In the generation management table, information concerning the generational area is stored, such as a top address of the generational area, an end address of the generational area, an end address of an area being used among the generational areas, a size of the generational area, identification information of the generational area, information concerning the reference update processing, information of a waiting event for the access restart, an access counter and the like.

In this embodiment, the generational area is identified as follows: GenerationEntry=Generation. Table [(obj_addr-heap_start)>>20]

Here, obj_addr is an address of the object, and heap_start is a start address of the heap area. Therefore, it is presumed that an address of object 1 is “01”, an address of object 2 is “02”, and an address of object 3 is “03”. Then, as for the object 1 illustrated in FIG. 16, GenerationEntry=Generation.table[(01-heap_start)>>20]=GenerationTable [1] is obtained. As for the object 2, GenerationEntry=Generation.table[(02-heap_start)>>20]=GenerationTable[2] is obtained. As for the object 3, GenerationEntry=Generation.table[(03-heap_start)>>20]=GenerationTable[3] is obtained.

Therefore, when accessing the object 1, GenerationTable[1].reference_updater is used, when accessing the object 2 and object 3, GenerationTable[1].reference_updater is used.

Moreover, in the reference update phase, the reference update processing is set to be valid as follows:

GenerationTable[N].reference_updater=reference_update;

Here, N is identification information of the generational area.

On the other hand, in a phase other than the reference update phase, the reference update processing is set to be invalid as follows: GenerationTable[N].reference_updater=reference_no_update;

Returning to the explanation of FIG. 15, the application processing unit 105 increments the access counter for the generational area identified at the step S81 by “1” (step S83).

The application processing unit 105 determines whether or not the reference pointer used in the processing of the step S81 was updated by another entity (e.g. marking unit 1031) (step S85). When it was updated (step S85: Yes route), the application processing unit 105 decrements the access counter for that generational area by “1” in order not to cause any error, and the processing returns to the processing of the step S81.

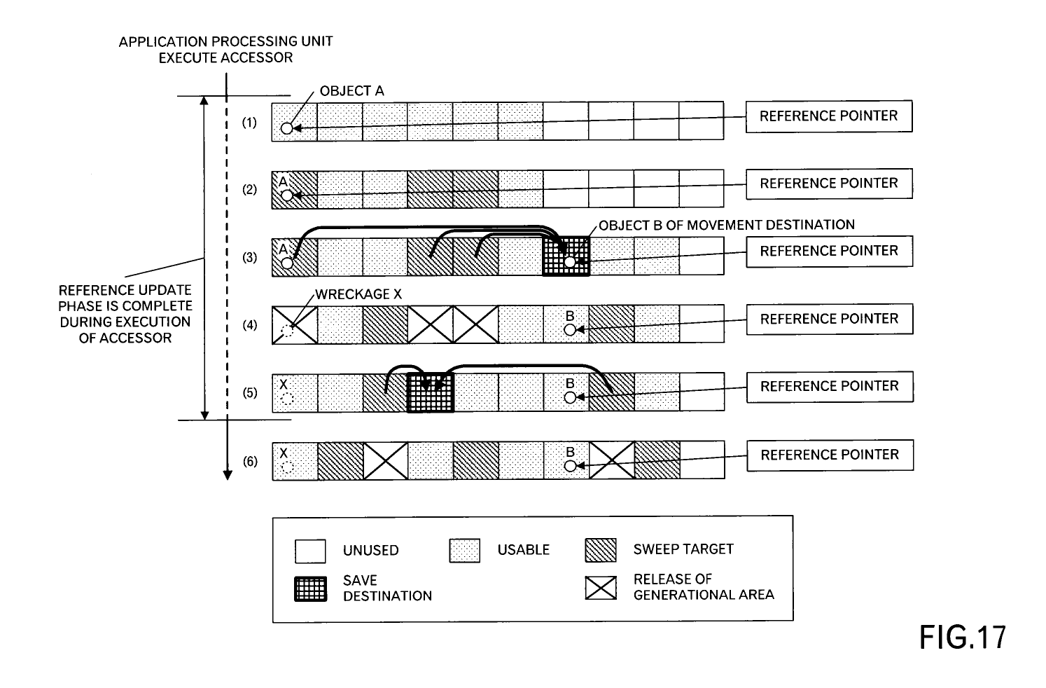

The processing of the steps S85 and S87 will be explained by using FIG. 17. In FIG. 17, the states (1) to (6) of the generational area are the same as the states (1) to (6) of the generational area in FIG. 5. For example, it is presumed that, before the state (1), the application processing unit 105 executes the accessor 109, and the access to the object A begins. In this case, until the state (3), there is no problem even when accessing the object A.

However, in case where, in the state (3), the reference pointer is updated so as to point to the object B of the movement destination, when the application processing unit 105 uses the reference pointer before the update, the access to the object A, which is the object of the destination source, continues. Then, when, in the state (5), the reference update phase is complete, and a generational area including a remain X is newly set up to make the generational area usable, the application processing unit 105 accesses a completely different object.

Then, at the step S85, when the reference pointer is updated after incrementing the access counter by “1”, the reference pointer is read again, and the processing returns to the processing of the step S81.

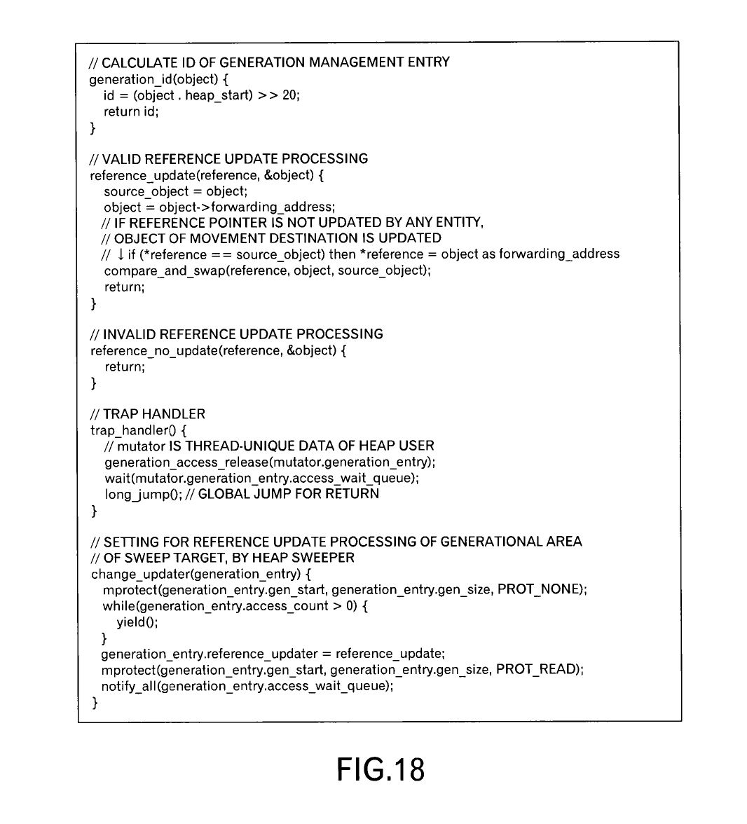

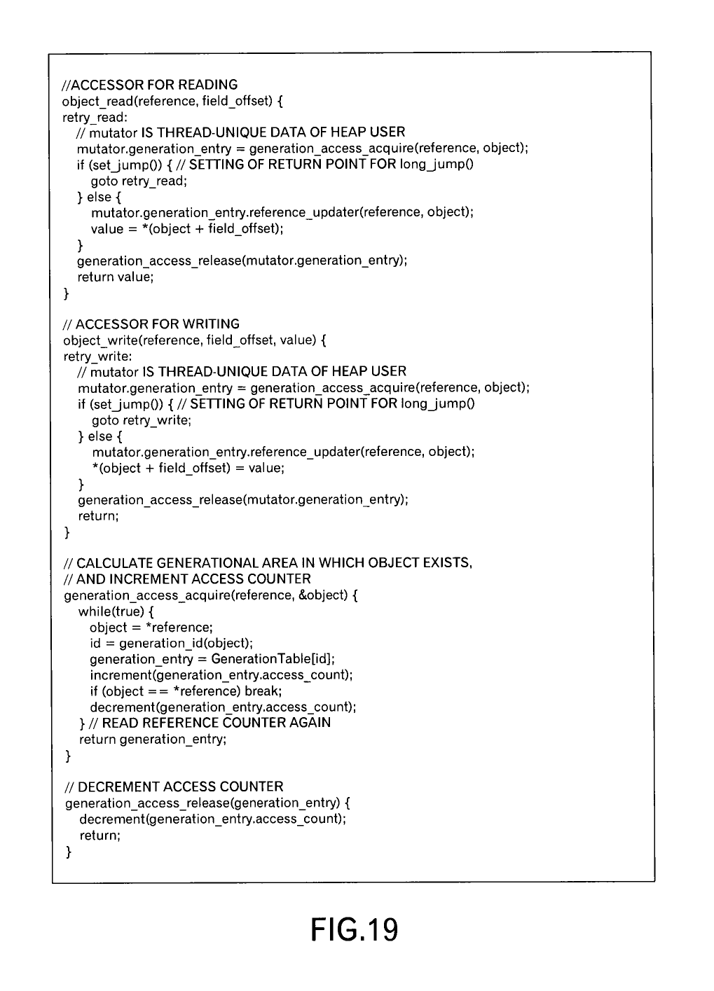

Here, an example of a program executed as the accessor 109 is illustrated in FIGS. 18 and 19. In the example of FIGS. 18 and 19, in this program, a code for a processing to calculate an ID of a generation management entry, a code for the reference update processing, a code for the trap handler, a code for a heap sweeper (i.e. garbage collector 103), a code for an accessor for writing, a code for an accessor for reading, and a code for increasing and decreasing the access counter are included. The reference pointer that points to an object of an access target and an offset value to a position of a field that is actually accessed (i.e. data stored in the object) are given to the accessor 109 as parameters. The processing of the reference update unit 111 is realized by portions of “valid reference update processing” and “invalid reference update processing” in FIG. 18.

Returning to the explanation of FIG. 15, when the generational area in which that object exists is not the sweep target (step S89: No route), the generational area is accessible as usual (i.e. PROT_READ|PROT_WRITE is set). Therefore, the application processing unit 105 accesses the object (i.e. reads data stored in the object or writes data to the object) (step S91). A case where the generational area is not the sweep target means a case in which that generational area is in the mark phase or non-sweep phase. Then, when the access ends, the application processing unit 105 decrements the access counter of the generational area including that object (step S93) by “1”. Then, the processing ends.

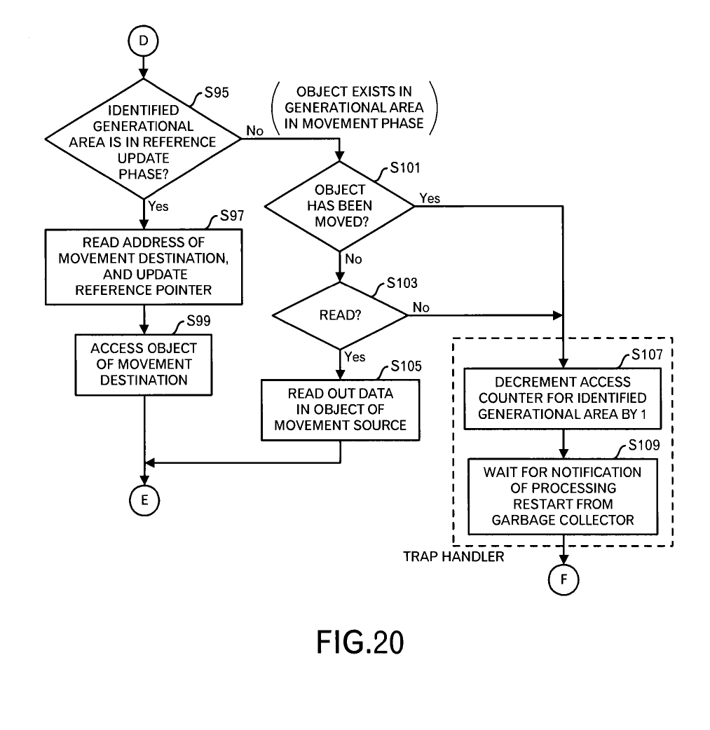

On the other hand, when that generational area is the sweep target (step S89: Yes route), the processing shifts to step S95 in FIG. 20 through terminal D. At the step S89, a case where the generational area is the sweep target means a case where the generational area is in the movement phase or reference update phase.

Shifting to explanation of FIG. 20, when the generational area including that object is in the reference update phase (step S95: Yes route), the address of the movement destination is stored in the object in that generational area. Therefore, the application processing unit 105 reads the address of the movement destination from the object in that generational area, and updates the reference pointer that points to that object with the address of the movement destination (step S97). However, when the reference pointer is updated by other application processing unit 105 or garbage collector 103, the reference pointer is not updated. Then, the application processing unit 105 accesses the object of the movement destination by the updated reference pointer (step S99). The processing shifts to step S93 in FIG. 15 through terminal E.

On the other hand, when the generational area including that object is not in the reference update phase (step S95: No route), that object exists in the generational area in the movement phase. Then, when the movement of the object in that generational area is not complete (step S101: No route), read-only is set to that generational area.

Therefore, when the access to the object is “read” (step S103: Yes route), the application processing unit 105 accesses that object for reading (step S105). Then, the processing shifts to the step S93 of FIG. 15 through the terminal E.

On the other hand, when the access to the object is “write” (step S103: No route), or when the movement of the object is complete (step S101: Yes route), the application processing unit 105 cannot access the object. Therefore, the application processing unit 105 decrements the access counter for that generational area by “1” (step S107). Moreover, the application processing unit 105 waits for a notification of the processing restart from the garbage collector 103 (step S109). The processing returns to the step S81 of FIG. 15 through terminal F.

By carrying out the aforementioned processing, when the application processing unit 105 actually accesses the object in the generational area of the sweep target, the reference pointer can be updated. Therefore, even when the object has been moved, the reference pointer that is not need to be updated is not updated.

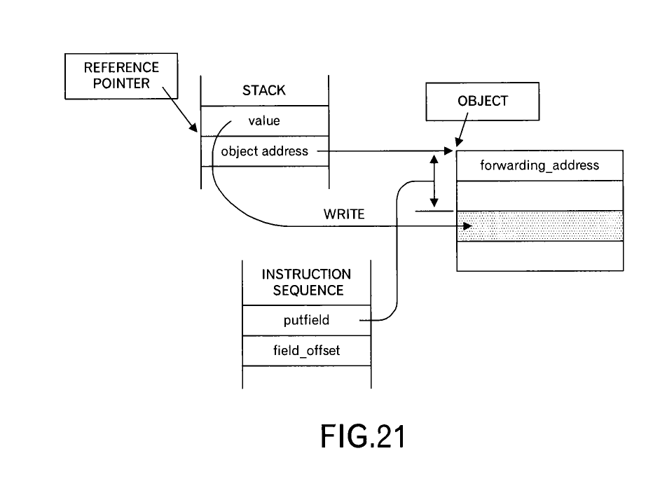

Specific examples of writing to the object will be explained by using FIGS. 21 to 23. FIG. 21 illustrates an example in which the writing to the object is executed by a putfield instruction. FIG. 21 also illustrates a stack, instruction sequence, and object. The reference pointer that points to the object accessed by the application processing unit 105 exists in the stack. The application processing unit 105 reads out an offset (field_offset) to a field to be accessed from an operand of the putfield instruction in the instruction sequence. Moreover, an assigned value (value) in the stack is stored at the position of the offset of the object.

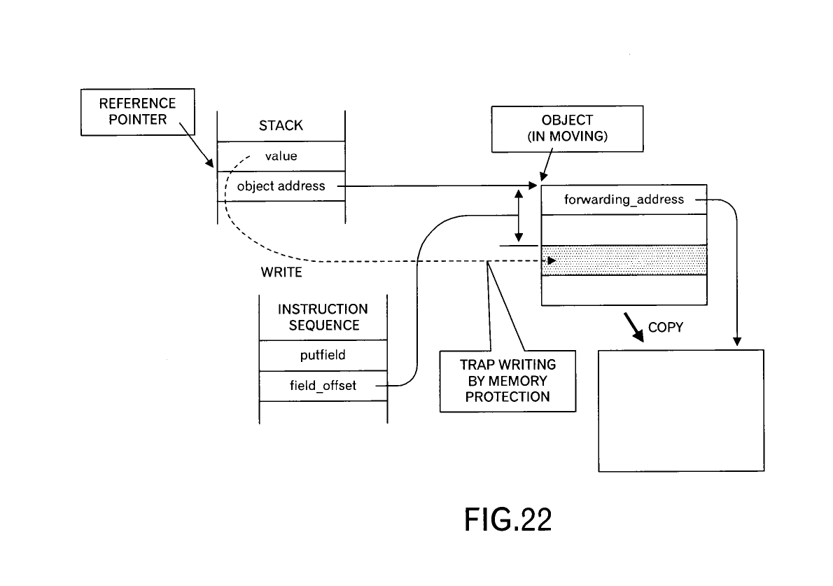

FIG. 22 illustrates an example in which the writing to the object by the putfield instruction is trapped during the movement of the object. The access method is similar to that in FIG. 21. However, when trying to store the assigned value in the stack at the position of the offset in the object being copied, a processing by the memory protection (in this case, PROT_READ) is trapped.

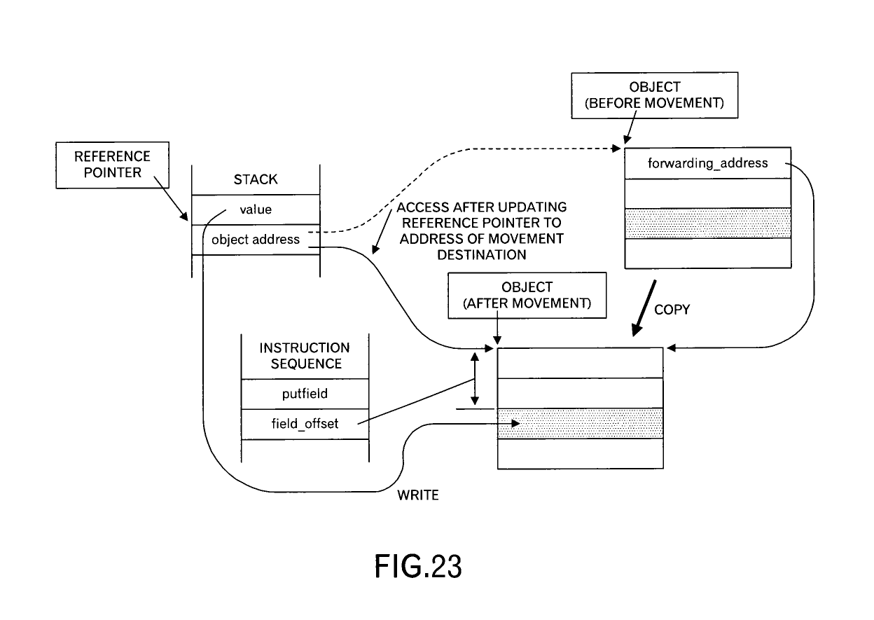

FIG. 23 illustrates an example in which the writing to the object by the putfiled instruction is performed after updating the reference pointer. The access method is similar to that in FIG. 21. However, while the application processing unit 105 executes the accessor 109 in order to store the assigned value at the position of the off set of the object before the movement, the reference pointer is updated by the reference update processing. In such a case, the assigned value is stored at the position of the offset in the object of the movement destination after updating the reference pointer.

Although one embodiment of this invention was explained, this invention is not limited to this embodiment. For example, a functional block configuration of the aforementioned information processing apparatus 1 does not always correspond to a program module configuration.

Moreover, the aforementioned table configurations are mere examples, and may be changed. Furthermore, as for the processing flow, as long as the processing results do not change, an order of steps may be changed and plural steps may be executed in parallel.

The garbage collector 103 releases the generational area after determining that the access counter becomes “0” at the step S33. However, the garbage collector 103 may update the reference in the accessor 109 being executed by the application processing unit 105 at the last of the mark phase. By carrying out such a processing, the processing of the step S33 is not executed.

Moreover, in case of Java, the accessor 109 may be switched according to the type of the object (e.g. instance object, class object, array object and the like). More specifically, the accessor 109 may be prepared for each instruction such as getfield, putfield, getstatic, putstatic, [a/b/c/s/i/l/f/d] aload, [a/b/c/s/j/f/d/d] astore and the like.

Moreover, an example that the memory protection is realized by PROT_READ|PROT_WRITE, PROT_READ and PROT_NONE was explained. However, incase of Windows (registered trademark), PAGE_READWRITE, PAGE_READ and PAGE_DECOMMIT are employed.

Moreover, when the generational area whose survival rate is less than 50%, for example, is identified as the sweep target, the areas corresponding to ⅓ of the heap area 101 only have to be reserved for the saving at the greatest. Therefore, when the total amount of live objects can be predicted based on the statistics obtained in advance for example, an area having an appropriate size that is equal to or greater than the size of one generational area and is equal to or less than the size of the area corresponding to ⅓ of the heap area 101 may be reserved. However, when the prediction is failed and the area for the saving is short, the parallel-type garbage collection is interrupted, and the processing of the application processing unit 105 is stopped. Then, the garbage collection is performed.

In case of the parallel-type garbage collection, generation of a new object and sweeping of unnecessary objects are executed in parallel. As for a difference between a generation amount of the objects and a sweeping amount of the objects, the statistics from the beginning of a specific mark phase to the beginning of a next mark phase are obtained to reflect the results to the start timing of the mark phase or increase or decrease of the generational area for the saving. When the generation amount of the objects is always greater than the sweeping amount of the objects, the system downs due to the lack of memory. Therefore, by acquiring the statistics, it becomes possible to cope with a problem that the generation amount is greater than the sweeping amount in the short term.

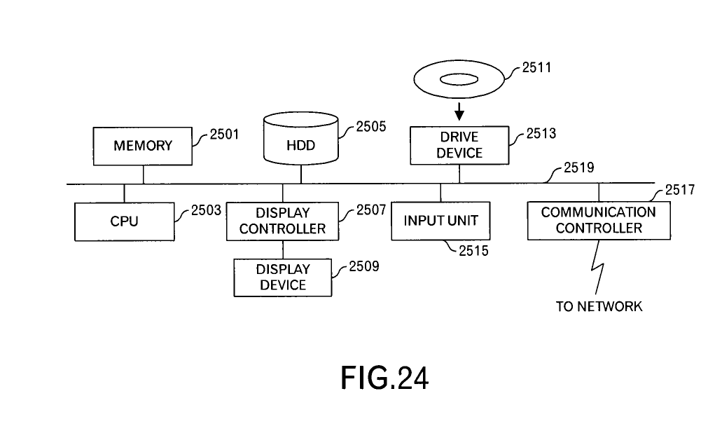

In addition, the aforementioned information processing apparatus 1 is a computer device as illustrated in FIG. 24. That is, a memory 2501 (storage device), a CPU 2503 (processor), a hard disk drive (HDD) 2505, a display controller 2507 connected to a display device 2509, a drive device 2513 for a removable disk 2511, an input device 2515, and a communication controller 2517 for connection with a network are connected through a bus 2519 as illustrated in FIG. 24. An operating system (OS) and an application program for carrying out the foregoing processing in the embodiment, are stored in the HDD 2505, and when executed by the CPU 2503, they are read out from the HDD 2505 to the memory 2501. As the need arises, the CPU 2503 controls the display controller 2507, the communication controller 2517, and the drive device 2513, and causes them to perform predetermined operations. Moreover, intermediate processing data is stored in the memory 2501, and if necessary, it is stored in the HDD 2505. In this embodiment of this technique, the application program to realize the aforementioned functions is stored in the computer-readable, non-transitory removable disk 2511 and distributed, and then it is installed into the HDD 2505 from the drive device 2513. It may be installed into the HDD 2505 via the network such as the Internet and the communication controller 2517. In the computer as stated above, the hardware such as the CPU 2503 and the memory 2501, the OS and the application programs systematically cooperate with each other, so that various functions as described above in details are realized.

The aforementioned embodiments of this invention are outlined as follows:

An information processing method relating to the embodiments includes: (A) identifying an object pointed by a first pointer from a heap area that is divided into plural areas; (B) determining whether or not an area in which the identified object exists is an area that is an area of a garbage collection target and from which a copy of objects has been completed; (C) upon detecting that the area in which the identified object exists is the area that is the area of the garbage collection target and from which the copy of the objects has been completed, obtaining an address of a movement destination of the identified object; and (D) updating the first pointer with the obtained address.

Thus, a time required for the update of the pointer is reduced without updating pointers that is unnecessary to be updated. Therefore, compared with some of the parallel-type garbage collection methods, it is possible to reduce a stop time of a processing for an application program.

Moreover, this information processing method may further include: (E) attaching a mark representing a live object to an object identified by the obtained address. This is because there is no need to attach any mark to objects in an area for which the garbage collection is carried out, and it is possible to maintain the consistency of the reference relationship if the mark is attached to objects of the movement destination.

Furthermore, this information processing method may further include: (F) upon detecting that a garbage collection is performed for a first area among the plural areas in the heap area, securing a second area that is an area of movement destinations of objects in the first area; (G) performing a setting so as to prohibit a processing unit that executes a processing of an application program by using the heap area from writing to the objects in the first area and so as to permit the processing unit to read from the objects in the first area; and (H) copying the objects in the first area to the second area. By doing so, even when the object is being moved, the reading from the objects in the area for which the garbage collection is carried out does not have to be stopped. Furthermore, writing and reading with respect to the objects in an area for which the garbage collection is not carried out do not have to be stopped. Moreover, because the writing to the objects in the area for which the garbage collection is carried out is prohibited, it is ensured that the object of the movement destination is the same as the object of the movement source.

In addition, the aforementioned securing may include (f1) storing an address of a movement destination of an object in the first area into the object in the first area. In addition, the processing unit may obtain an address of a movement destination of a certain object in the first area from the certain object, when accessing the certain object for reading or writing, update a second pointer that points to the certain object with the obtained address, and access an object copied in the second area by the updated second pointer. By carrying out the aforementioned processing, because the reference pointer is updated when the processing that executes the processing of the application program actually accesses the area for which the garbage collection is performed, extra reference pointers are not updated.

Moreover, this information processing method may further include: (I) determining whether or not a processing unit that accesses an object in the first area exists, by using a counter to count a number of processing units that is accessing; and (J) upon determining that there is no processing unit that accesses an object in the first area, releasing the first area. Thus, because the area is not released while the processing accesses the object, it is possible to avoid an occurrence of any problem.

In addition, this information processing method may further include: (K) performing a setting for enabling any one of released areas among the plural areas to be read and written by the processing unit. By doing so, it is possible for the processing unit to perform a processing by using the area for which the setting was made.

Furthermore, the aforementioned securing may include (f2) identifying an area for which a garbage collection is performed based on a size of live objects or a number of live objects from among the plural areas. Thus, it becomes possible to appropriately identify an area for which the garbage collection is to be carried out.

Incidentally, it is possible to create a program causing a computer to execute the aforementioned processing, and such a program is stored in a computer readable storage medium or storage device such as a flexible disk, CD-ROM, DVD-ROM, magneto-optic disk, a semiconductor memory, and hard disk. In addition, the intermediate processing result is temporarily stored in a storage device such as a main memory or the like.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. An information processing method, comprising:
specifying, by using a processor, a first object pointed by a first pointer, wherein the first object is in a heap area that includes a plurality of generational areas;
determining, by using the processor, whether or not an address in a generational area, which is different from a first generational area that includes the first object, is set as a movement destination address of the first object;
upon determining that the address is set as the movement destination address of the first object, obtaining, by using the processor, the movement destination address of the first object; and
updating, by using the processor, the first pointer with the movement destination address of the first object.

2. The information processing method as set forth in claim 1, wherein the determining comprises:
determining whether or not the first generational area is set as a generational area that is in a phase to update the first pointer.

3. The information processing method as set forth in claim 1, further comprising:
attaching a mark that represents a live object to an object specified by the obtained movement destination address.

4. The information processing method as set forth in claim 1, further comprising:
upon detecting that a garbage collection is performed for the first generational area among the plurality of generational areas in the heap area, securing a second generational area that is a generational area of movement destinations of objects in the first generational area;
performing a setting so as to prohibit a processing unit that executes a processing of an application program by using the heap area from writing to the objects in the first generational area and so as to permit the processing unit to read from the objects in the first generational area; and
copying the objects in the first generational area to the second generational area.

5. The information processing method as set forth in claim 4, wherein the securing comprises:
storing an address of a movement destination of an object in the first generational area into the object in the first generational area, and
the processing unit obtains a movement destination address of a certain object in the first generational area from the certain object, when accessing the certain object for reading or writing, updates a second pointer that points to the certain object with the obtained movement destination address, and accesses an object copied in the second generational area by the updated second pointer.

6. The information processing method as set forth in claim 5, further comprising:
determining whether or not a processing unit that accesses an object in the first generational area exists, by using a counter to count a number of processing units that is accessing; and
upon determining that there is no processing unit that accesses an object in the first generational area, releasing the first generational area.

7. The information processing method as set forth in claim 6, further comprising:
performing a setting for enabling any one of released generational areas among the plurality of generational areas to be read and written by the processing unit.

8. A computer-readable, non-transitory storage medium storing a memory control program for causing a computer to execute a process comprising:
specifying a first object pointed by a first pointer, wherein the first object is in a heap area that includes a plurality of generational areas;
determining whether or not an address in a generational area, which is different from a first generational area that includes the first object, is set as a movement destination address of the first object;
upon determining that the address is set as the movement destination address of the first object, obtaining the movement destination address of the first object; and
updating the first pointer with the movement destination address of the first object.

9. The computer-readable, non-transitory storage medium as set forth in claim 8, wherein the determining comprises:
determining whether or not the first generational area is set as a generational area that is in a phase to update the first pointer.

10. The computer-readable, non-transitory storage medium as set forth in claim 8, wherein the memory control process further comprises:
attaching a mark that represents a live object to an object specified by the obtained movement destination address.

11. The computer-readable, non-transitory storage medium as set forth in claim 8, wherein the process further comprises:
upon detecting that a garbage collection is performed for the first generational area among the plurality of generational areas in the heap area, securing a second generational area that is a generational area of movement destinations of objects in the first generational area;
performing a setting so as to prohibit a processing unit that executes a processing of an application program by using the heap area from writing to the objects in the first generational area and so as to permit the processing unit to read from the objects in the first generational area; and
copying the objects in the first generational area to the second generational area.

12. The computer-readable, non-transitory storage medium as set forth in claim 11, wherein the securing comprises:
storing an address of a movement destination of an object in the first generational area into the object in the first generational area, and
the processing unit obtains a movement destination address of a certain object in the first generational area from the certain object, when accessing the certain object for reading or writing, updates a second pointer that points to the certain object with the obtained movement destination address, and accesses an object copied in the second generational area by the updated second pointer.

13. The computer-readable, non-transitory storage medium as set forth in claim 12, wherein the process further comprises:
determining whether or not a processing unit that accesses an object in the first generational area exists, by using a counter to count a number of processing units that is accessing; and
upon determining that there is no processing unit that accesses an object in the first generational area, releasing the first generational area.

14. The computer-readable, non-transitory storage medium as set forth in claim 13, wherein the process further comprises:
performing a setting for enabling any one of released generational areas among the plurality of generational areas to be read and written by the processing unit.

15. An information processing apparatus comprising:
a memory; and
a processor configured to use the memory and execute a process comprising:
specifying a first object pointed by a first pointer, wherein the first object is in a heap area that includes a plurality of generational areas;
determining whether or not an address in a generational area, which is different from a first generational area that includes the first object, is set as a movement destination address of the first object;
upon determining that the address is set as the movement destination address of the first object, obtaining the movement destination address of the first object; and
updating the first pointer with the movement destination address of the first object.
